(19) United States
(12) Patent Application Publication
(10) Pub. No.: US 2010/0217962 A1
(43) Pub. Date: Aug. 26, 2010

(54) PREDICTING A CONDITIONAL BIT VALUE FOR CONTINUING EXECUTION OF AN INSTRUCTION

(75) Inventor: Alexander Freidin, Petah Tiqwa (IL)

Correspondence Address: Duft Bornsen & Fishman LLP, 1526 Spruce Street, Suite 302, Boulder County, CO, 80302, US

(73) Assignee: LSI CORPORATION, Milpitas, CA (US)

(21) Appl. No.: 12/393,269

(22) Filed: Feb. 26, 2009

(51) Int. Cl. G06F 9/38

(52) U.S. Cl. 712/239; 712/E09.045

(57) ABSTRACT

Methods and microprocessors are provided for continuing execution of an instruction, even though execution of the instruction depends on a value of a conditional bit (e.g., a flag bit or a predicated bit) that has not been determined. Rather than stalling execution of the instruction, a predicted value of the conditional bit is predicted and execution of the instruction is continued based on the predicted value of the conditional bit. If the predicted value matches a determined value of the conditional bit, a result from continuing execution of the instruction is committed. An existing branching prediction block of a microprocessor might be extended to support this mechanism.

### BACKGROUND

1. Field of the Invention

The invention relates generally to microprocessor techniques and more specifically relates to predicting a value for continuing execution of an instruction.

2. Discussion of Related Art

Microprocessors have been used in a wide variety of applications for processing data. For example, microprocessors may be found in small devices (e.g., MP3 players), personal computers, and large mainframes. One reason that gives rise to the flexibility and popularity of microprocessors is that different software may be written for a microprocessor. The microprocessor simply executes instructions of a given software and processes data in accordance with the instructions.

Modern microprocessors employ a wide variety of techniques to speed up processing of the instructions. One such technique is known as pipelining. Under this technique, a pipeline of a microprocessor may be seen as an assembly line of a factory, and the pipeline has various execution stages just like the assembly line also has various production stages. Production of a product by the factory is divided into the productions stages. Similarly, execution of the instruction by the microprocessor using the pipeline is also divided into the execution stages. The instruction being executed through the pipeline may be seen as the product being produced through the assembly line.

The assembly line allows different production stages of the factory to be more fully occupied. For example, while the wheels of a first car (which already has its engine installed) are being installed, the engine of a second car may also be installed at the same time so neither production stage is idled. Similarly, the pipeline allows different execution stages of the microprocessor to be more fully occupied by different instructions, rather than processing one instruction at a time while idling the execution stages that are not used by the instruction.

However, running the pipeline is more complicated than running the assembly line, for example because production of the second car typically does not depend on output of the first car. Suppose the pipeline includes the following executions stages: reading data to be processed, processing the data, and writing the processed data out. Further suppose that when a latter instruction is at the stage of reading data, but the data has not been written out by a previous instruction. The latter instruction must then stall and cannot proceed until the previous instruction has finished writing out the data. Stalling the latter instruction not only slows down processing of the latter instruction, but all subsequent instructions as well.

Thus it is an ongoing challenge to speed up processing of the instructions by reducing the number of pipeline stalls.

### SUMMARY

The present invention solves the above and other problems, thereby advancing the state of the useful arts, by providing methods and microprocessors for continuing execution of an instruction, even though execution of the instruction depends on a value of a conditional bit that has not been determined by an earlier instruction. Rather than stalling execution of the instruction, a predicted value of the conditional bit is predicted and execution of the instruction is continued based on the predicted value of the conditional bit. If the predicted value matches a determined value of the conditional bit, a result from continuing execution of the instruction is committed. Beneficially, the number of pipeline stalls caused by conditional bit dependency is reduced, and processing of the instructions is sped up.

In one aspect hereof, a method is provided for continuing execution of an instruction in a microprocessor. Execution of the instruction depends on a value of a conditional bit, and a determined value of the conditional bit has not been determined. The method comprises predicting a predicted value of the conditional bit. The method also comprises continuing execution of the instruction based on the predicted value of the conditional bit. Additionally, the method comprises committing a result from continuing execution of the instruction if the predicted value matches the determined value of the conditional bit.

Another aspect hereof provides a microprocessor for continuing execution of an instruction in that execution of the instruction depends on a value of a conditional bit, and a determined value of the conditional bit has not been determined. The microprocessor comprises a predicting element for predicting a predicted value of the conditional bit. The microprocessor also comprises a processing element for continuing execution of the instruction based on the predicted value of the conditional bit. Additionally, the microprocessor comprises a committing element for committing a result from continuing execution of the instruction if the predicted value matches the determined value of the conditional bit.

Yet another aspect hereof provides a method for continuing execution of an instruction. Execution of the instruction depends on values of a plurality of conditional bits, and at least one determined value of the plurality of conditional bits has not been determined. The method comprises predicting a predicted combination of the values of the plurality of conditional bits, and continuing execution of the instruction based on the predicted combination of the values. The method also comprises committing a result from continuing execution of the instruction if the predicted combination of the values is consistent with the at least one determined value.

### BRIEF DESCRIPTION OF THE DRAWINGS

FIG. 1 is a block diagram demonstrating exemplary execution stages of two instructions in accordance with features and aspects hereof.

FIG. 2 is a flowchart describing an exemplary method in accordance with features and aspects hereof to continue execution of an instruction.

FIG. 3 is a flowchart describing another exemplary method in accordance with features and aspects hereof to continue execution of an instruction.

FIG. 4 is a block diagram of an exemplary microprocessor for continuing execution of an instruction in accordance with features and aspects hereof.

### DETAILED DESCRIPTION OF THE DRAWINGS

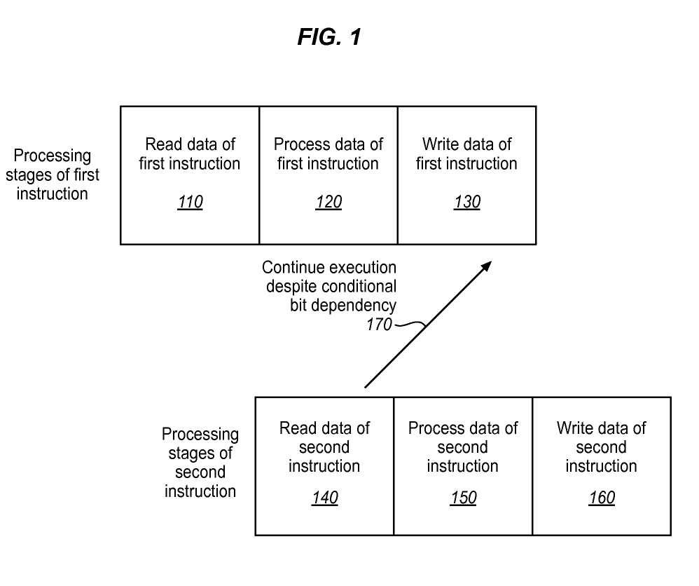

FIG. 1 is a block diagram demonstrating exemplary execution stages of two instructions in accordance with features and aspects hereof. Processing stages of a first instruction comprises reading data of the first instruction 110, processing data of the first instruction 120, and writing data of the first instruction 130. For example, suppose the first instruction is to test whether a value is zero, and if so, set a flag to true. During the stage of reading data of the first instruction 110, the processor would read the value. During the stage of processing data of the first instruction 120, the processor would test whether the value is zero. During the stage of writing data of the first instruction 130, the processor would set the flag to true if the value has been determined to be zero by the test.

Processing stages of a second instruction similarly comprises reading data of the second instruction 140, processing data of the second instruction 150, and writing data of the second instruction 160. Suppose the second instruction is to increment a second value if the flag has been set to true. During the stage of reading data of the second instruction 140, the processor would read the second value and a value of the flag. It would be ideal for reading data of the second instruction 140 to occur right after reading data of the first instruction 110, and to occur simultaneously with processing data of the first instruction 120. However, this cannot occur as known in the art because the value of the flag is not updated until writing data of the first instruction 130 has been completed. Rather, as known in the art, reading data of the second instruction 140 would occur after writing data of the first instruction 130 has been completed, stalling execution of the second instruction.

Advantageously, methods and microprocessors are provided herein for continuing execution of the second instruction despite the conditional bit dependency 170 as indicated by the arrow (i.e., reading data of the second instruction 140 depends on writing data of the first instruction 130). During the stage of reading data of the second instruction 140, a predicted value of the flag is predicted in the above example (that the second instruction is to increment the second value if the flag has been set to true). Suppose the predicted value has been predicted to be true. During the stage of processing data of the second instruction 150, which can occur in parallel with writing data of the first instruction 130 by using the predicted value, the second value is incremented because the flag has been predicted to be true.

During the stage of writing data of the second instruction 160, the processor compares the predicted value with a determined value that has actually been determined during the stage of writing data of the first instruction 130. If the values match, the prediction is successful, and a result of incrementing the second value is committed by actually updating the second value. If the values do not match, the prediction is unsuccessful, and execution of the second instruction is rewound so that execution of the second instruction is based on the determined value of the flag (in many instances, the processor simply discards the result from executing the second instruction as if the second instruction has not been executed at all).

The “conditional bit,” including that mentioned in the conditional bit dependency 170 described above, comprises, for example, one of a flag bit and a single-bit predicate register. The flag bit comprises, for example, one of zero flag, true flag, overflow flag, sign flag, carry flag, and any of other single-bit flags (typically in a status register) in a processor. For example, if a value is tested to be zero, a zero flag would be set to true (i.e., value is set to one). Alternatively, if the processor comprises a true flag instead of the zero flag, the true flag would be set to false (i.e., value is set to zero). Typically, a flag is one-bit long and is set implicitly (because each flag is associated with a specific condition) as a result of executing an instruction. The single-bit predicate register is typically set explicitly (because each single-bit predicate register is not associated with a specific condition) to hold a result of a compare instruction, and is typically later used for conditional execution of one or more instructions. Whereas the flag is typically not specified as an operand of the instruction, the single-bit predicate register is specified as an operand. However, whereas an operand typically comprises a plurality of bits, the single-bit predicate register is one-bit long. Additionally, whereas operations are typically performed on an operand, operations are not directly performed on a single-bit predicate register.

The type of instruction likely to benefit from the provided methods and microprocessors comprises one of a flag dependant instruction and a predicated instruction. A “flag dependant instruction” is an instruction the execution of which depends on a value of a flag. For example, a “flag dependant instruction” may be a conditional instruction, or an instruction like “ADC” (add with carry). A “predicated instruction” is an instruction the execution of which depends on a value of a single-bit predicate register. Meanwhile, the value of a conditional bit may depend on a number of other conditional bits. For example, a predicated instruction may depend on a first single-bit predicate register. The value of the first single-bit predicate register may further depend on a second single-bit predicate register. As a result, the predicated instruction depends on at least two single-bit predicate registers. Similarly, a flag dependant instruction may also depend on a combination of flags. For example, if the carry flag is set but the zero flag is not set, the condition can be interpreted as one operand being higher than the other operand in a previous compare operation. A flag dependant instruction may thus be specified so that it is executed when the condition is “higher” based on the at least two flags.

The provided methods and microprocessors may benefit many types of instructions including branch instructions. However, in some instances the type of instruction to benefit from the provided methods and microprocessors may be other than a branch instruction. It is noted that in some instances, executing a branch instruction involves the use a branch predictor, which as presently known is directed to predicting whether or not to take a branch. The branch predictor does not predict a value of a conditional bit, and also does not predict a value of a conditional bit that is accessible by an instruction and/or can be specified (whether implicitly or explicitly) in an instruction.

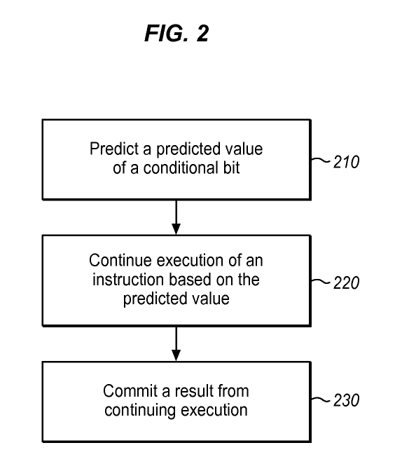

FIG. 2 is a flowchart describing an exemplary method operable in an enhanced pipelined microprocessor for each instruction in accordance with features and aspects hereof to continue execution of an instruction. Execution of the instruction depends on a value of a conditional bit, in that a determined value of the conditional bit has not been determined. At step 210, the processor predicts a predicted value of the conditional bit. At step 220, the processor continues execution of the instruction based on the predicted value rather than stalling until the determined value has been determined. At step 230, the processor commits a result from continuing execution of the instruction if the predicted value matches the determined value of the conditional bit.

As noted above, a predicated instruction may depend on at least two single-bit predicate registers, and a flag dependant instruction may also depend on a combination of flags. However, at least one determined value of the plurality of conditional bits may not have been determined. Accordingly, the processor may predict a predicted combination of the values of a plurality of conditional bits at step 210. At step 220, the processor may continue execution of the instruction based on the predicted combination of the values. At step 230, the processor may commit a result from continuing execution of the instruction if the predicted combination of the values is consistent with the at least one determined value.

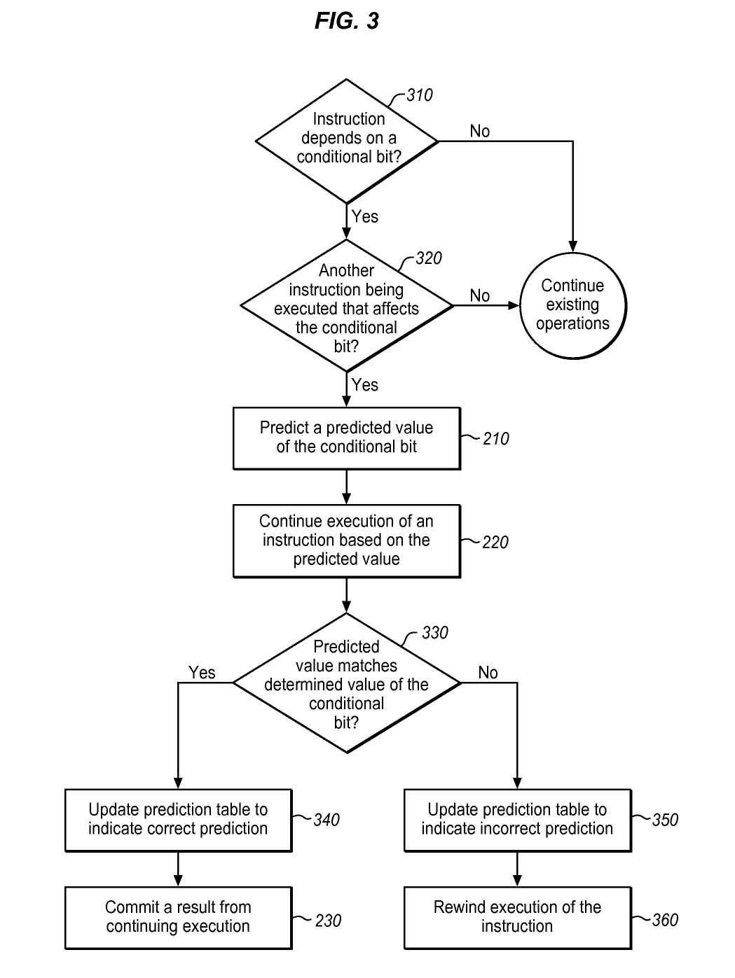

FIG. 3 is a flowchart describing another exemplary method in accordance with features and aspects hereof to continue execution of an instruction. Execution of the instruction also depends on a value of a conditional bit, in that a determined value of the conditional bit has not been determined. At step 310, the processor may determine whether the instruction depends on a condition bit. If not, the processor continues existing operations. If so, at step 320 the processor may determine whether another instruction is also being executed (e.g., already being processed in the pipeline) that might affect the conditional bit. If not, the processor also continues existing operations as the present instruction does not depend on another instruction, and there is no need to make any prediction of the value of the conditional bit to continue executing the present instruction.

If another instruction being executed might affect the conditional bit, the processor predicts at step 210 a predicted value of the conditional bit. In some instances, the processor may always predict a value such that the instruction continues execution. This is because if the processor determines later that the instruction should not be executed, a result from executing the instruction may simply be discarded. However, in other instances, the processor may always predict a value such that the instruction “continues” execution without stalling but without any actual processing (i.e., as if the instruction is not actually executed), perhaps to prevent any possible unnecessary processing and to lower power consumption. Indeed, the word “continues” is quoted (and will be quoted in subsequent paragraphs) to mean that execution of the instruction does not stall the pipeline, because the instruction is simply not actually executed. In some instances, the processor may start executing a subsequent instruction (subsequent to the instruction that is not actually executed).

In other instances, the processor may access a prediction table, typically to support dynamic prediction. Accessing the prediction table may be based on at least a portion of an address of the instruction because the size of the prediction table is limited. The prediction table may also be accessed based on the type of the instruction, the type of the conditional bit, and/or other characteristics of the instruction. If no existing entry is found in the prediction table, a new entry may be added and a default or a random predicted value may be used. Alternatively, if no existing entry is found, no prediction is made and execution of the instruction is stalled until the determined value of the conditional bit has been determined. The prediction table is then updated based on the determined value of the conditional bit, and the processor then continues existing operations.

In certain instances, the prediction table is also used for branch prediction (i.e., a single table is shared for both purposes); in such instances the single table may be enlarged as more predictions need to be made for more instructions. In the prediction table, a single bit may be used to make the prediction, and two or more bits (representing earlier predictions) may also be used so that the prediction is based on a history of various lengths of past predictions. It is noted that the prediction table may comprise a number of smaller tables that can be accessed in parallel when there are multiple instructions. Additionally, no particular ordering is imposed for the various steps (e.g., among steps 310, 320, and 210) in FIG. 3.

At step 220, the processor continues execution of the instruction based on the predicted value. As noted above, in some instances execution is “continued” in the sense that the pipeline is not stalled, but the instruction is not actually executed. Also as noted above, the processor may start executing a subsequent instruction instead of executing the instruction. At step 330, the processor may determine whether the predicted value matches a determined value of the conditional bit that has since been determined (e.g., by another instruction identified at step 320).

If the values match and a prediction table is used for dynamic prediction, the processor may update the prediction table to indicate a correct prediction at step 340. For example, if the entry for the instruction in the prediction table indicates that the prediction is weak, the prediction may now be changed to be strong. This is so that if a later prediction is incorrect, the prediction may be dropped back to weak rather than predicting the opposite value right away. If only a single bit is used in the prediction table or no prediction table is used, the step 340 may be skipped. At step 230, the processor commits a result from continuing execution so that if the instruction has actually been executed, value(s) that are affected are actually updated and/or written out. If execution has been “continued” to avoid stalling the pipeline, but the instruction has not actually been executed, then no value is actually updated.

If the values do not match and a prediction table is used for dynamic prediction, the processor may update the prediction table to indicate an incorrect prediction at step 350. For example, if the entry for the instruction in the prediction table indicates that the prediction is weak, the prediction may now be switched to be weak for an opposite predicted value. If only a single bit is used in the prediction table, the prediction may now be changed to an opposite predicted value. If no prediction table is used, the step 350 may be skipped. At step 360, the processor rewinds execution of the instruction so that if the instruction has actually been executed, no result is written out. The processor may also flush the pipeline or use other known techniques. If execution has been “continued” to avoid stalling the pipeline and the instruction has not actually been executed, the processor needs to actually execute the instruction as it should. Additionally, if the processor has already started to execute a subsequent instruction, the processor may flush the pipeline or use other known techniques for arriving at correct execution results.

Those of ordinary skill in the art will readily recognize numerous additional and equivalent steps that may be performed and/or omitted in the methods of FIGS. 2 and 3. Such additional and equivalent steps are omitted herein merely for brevity and simplicity of this discussion.

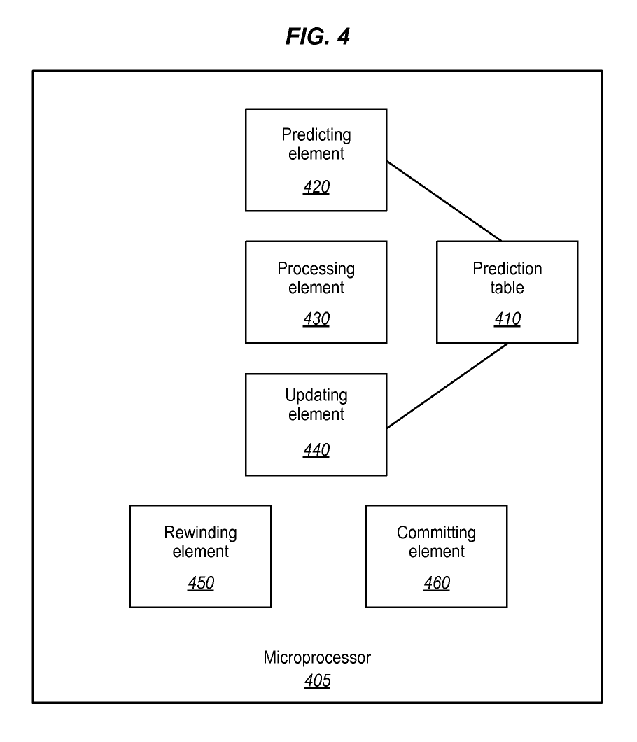

FIG. 4 is a block diagram of an exemplary microprocessor for continuing execution of an instruction in accordance with features and aspects hereof. Execution of the instruction depends on a value of a conditional bit, but a determined value of the conditional bit has not been determined. The microprocessor 405 comprises a predicting element 420 for predicting the predicted value of the conditional bit. The predicting element 420 may make the prediction by accessing a prediction table 410. The microprocessor 405 also comprises a processing element 430 for continuing execution of the instruction based on the predicted value of the conditional bit. The processing element 430 may simply be an existing element of the microprocessor 405 for executing the instruction.

Additionally, the microprocessor 405 comprises a committing element 460 for committing a result from continuing execution of the instruction if the predicted value matches the determined value of the conditional bit. Similarly, the microprocessor 405 may comprise a rewinding element 450 for rewinding execution of the instruction when the predicted value does not match the determined value of the conditional bit. The rewinding element 450 and the committing element 460 may be similar to existing element(s) for handling branch predictions. The microprocessor 405 may also comprise an updating element 440 for updating the prediction table 410 based on whether the predicted value matches the determined value of the conditional bit.

The prediction table 410 allows certain history of past predictions to be stored to support dynamic prediction. The prediction table 410 comprises entries that can be accessed by at least a portion of an address of an instruction (and/or other characteristics of the instruction as noted above), and each entry comprises one or more bits for recording a history of various lengths of past predictions. In some instances, the prediction table 410 is also used for branch prediction. The microprocessor 405 may be any of a number of varieties of processing elements that execute instructions. For example, the microprocessor 405 may comprise a digital signal processor (“DSP”), a microcontroller, a central processing unit (“CPU”) or any of a number of other types of processors. Additionally, the microprocessor 405 and its elements may be implemented using customized integrated circuits, programmable logic, and/or even emulated in software.

Those of ordinary skill in the art will readily recognize numerous additional and equivalent components and modules within a fully functional microprocessor. Such additional and equivalent components are omitted herein for simplicity and brevity of this discussion. Thus, the structure of FIG. 4 is intended merely as representatives of exemplary embodiments of features and aspects hereof.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for continuing execution of an instruction in a microprocessor, wherein execution of the instruction depends on a value of a conditional bit, and wherein a determined value of the conditional bit has not been determined, the method comprising:
predicting a predicted value of the conditional bit;
continuing execution of the instruction based on the predicted value of the conditional bit; and
committing a result from continuing execution of the instruction if the predicted value matches the determined value of the conditional bit.

2. The method of claim 1, wherein the conditional bit comprises one of a flag bit and a single-bit predicate register.

3. The method of claim 2, wherein the flag bit comprises one of zero flag, true flag, overflow flag, sign flag, and carry flag.

4. The method of claim 1, wherein the instruction comprises one of a flag dependant instruction and a predicated instruction.

5. The method of claim 1, wherein the instruction is other than a branch instruction.

6. The method of claim 1, wherein the step of predicting comprises:
accessing a prediction table based on at least a portion of an address of the instruction.

7. The method of claim 6, wherein the prediction table is also used for branch prediction.

8. The method of claim 1, further comprising:
updating a prediction table based on whether the predicted value matches the determined value of the conditional bit.

9. The method of claim 1, further comprising:
rewinding execution of the instruction when the predicted value does not match the determined value of the conditional bit.

10. The method of claim 1, further comprising:
determining whether the instruction depends on the conditional bit; and
detecting whether another instruction is being executed, wherein execution of the another instruction determines the determined value of the conditional bit.

11. A microprocessor for continuing execution of an instruction, wherein execution of the instruction depends on a value of a conditional bit, and wherein a determined value of the conditional bit has not been determined, the microprocessor comprising:
a predicting element for predicting a predicted value of the conditional bit;
a processing element for continuing execution of the instruction based on the predicted value of the conditional bit; and
a committing element for committing a result from continuing execution of the instruction if the predicted value matches the determined value of the conditional bit.

12. The microprocessor of claim 11, wherein the conditional bit comprises one of a flag bit and a single-bit predicate register, and wherein the flag bit comprises one of zero flag, true flag, overflow flag, sign flag, and carry flag.

13. The microprocessor of claim 11, wherein the instruction is other than a branch instruction, and wherein the instruction comprises one of a flag dependant instruction and a predicated instruction.

14. The microprocessor of claim 11, further comprising a prediction table, and wherein the predicting the predicted value comprises accessing the prediction table based on at least a portion of an address of the instruction.

15. The microprocessor of claim 14, wherein the prediction table is also used for branch prediction.

16. The microprocessor of claim 11, further comprising:
a prediction table; and
an updating element for updating the prediction table based on whether the predicted value matches the determined value of the conditional bit.

17. The microprocessor of claim 11, further comprising:
a rewinding element for rewinding execution of the instruction when the predicted value does not match the determined value of the conditional bit.

18. The microprocessor of claim 11, further comprising:
a determining element for determining whether the instruction depends on the conditional bit; and
a detecting element for detecting whether another instructions is being executed, wherein execution of the another instruction determines the determined value of the conditional bit.

19. A method for continuing execution of an instruction, wherein execution of the instruction depends on values of a plurality of conditional bits, and wherein at least one determined value of the plurality of conditional bits has not been determined, the method comprising:
predicting a predicted combination of the values of the plurality of conditional bits;
continuing execution of the instruction based on the predicted combination of the values; and
committing a result from continuing execution of the instruction if the predicted combination of the values is consistent with the at least one determined value.

20. The method of claim 19, wherein:
each of the plurality of conditional bits comprises one of a flag bit and a single-bit predicate register, and wherein the flag bit comprises one of zero flag, true flag, overflow flag, sign flag, and carry flag;
the instruction is other than a branch instruction; and
the instruction comprises one of a flag dependant instruction and a predicated instruction.
